(19) United States
(12) Patent Application Publication
(10) Pub. No.: US 2007/0112453 A1
(43) Pub. Date: May 17, 2007

(54) Method for making an adapted software product

(76) Inventors: Jean-Marc Auriol, Flourens (FR); Philippe Bornes, Flourens (FR)

Correspondence Address: Jackson Patent Law Office, Suite 100, 211 N Union Street, Alexandria, VA, 22314, US

(21) Appl. No.: 10/570,383

(22) PCT Filed: Sep. 3, 2004
(86) PCT No.: PCT/FR04/50413

§ 371 Date: Oct. 13, 2006

(30) Foreign Application Priority Data
Sep. 4, 2003 (FR) 0310499

(51) Int. Cl. G06F 19/00

(52) U.S. Cl. 700/114; 700/176

(57) ABSTRACT

The invention concerns a manufacturing method requiring precise positioning of fixing components relative to another receiving component designed to receive same, the positioning being carried out by means of an equipment provided therefor, characterized in that it consists in measuring the components designed to be positioned to ascertain the tolerance curve (C) of said components and in modifying the settings of the positioning equipment such that the curve (C) for dimensioning the components is in the middle of the positioning tolerance zone. The invention also concerns an adapted software product. The invention is useful for the statistical control of processes in particular for piercing/riveting processes.

### FIELD OF THE INVENTION

The present invention is related to the domain of statistical process control (SPC) and notably to adaptations enabling realization of boring-riveting operations with required indices of capacity.

### DESCRIPTION OF THE PRIOR ART

In the field, taken as an example, of fastening by rivet and notably of fastening by rivet having a countersunk head, the positioning tolerances become more and more rigorous.

The positioning dispersion of a rivet having a countersunk head in the interior of a pre-countersunk orifice depends on a number of criteria, among them:
the dimensioning tolerances of the rivet, and
the adjustment of the countersinking tool.

In order to conform to the positioning tolerances, there exists in the prior art a technique that comprises, starting from a batch of rivets, carrying out a first adjustment of the countersinking tool and verifying if the positioning of the rivet in the interior of the countersunk hole is optimal. If the verification (most of the time manual or visual) reveals a correct positioning, it is considered that the totality of operations performed on this batch of rivets with the tool adjusted as it is will provide a positioning within the required tolerances. In the contrary case, a new adjustment of the tool and a new verification are performed until achieving the correct positioning for commencing the boring-riveting operations on the entire batch. This technique is that proposed notably by the U.S. Pat. No. 5,615,474, which describes an automatic machine for riveting or setting of fastenings including a method of statistical control. This document describes a system of control for operating and monitoring of the functioning of an automatic machine for setting of fastenings such as an automatic boring-riveting machine, by compilation, recording, and use of data from each boring-riveting cycle. This cycle of data becomes therefore a part of a global recording that is useful for updating the maintenance programs, for establishing the cycle trends in real time, and for creating a log, the trends in real time being particularly useful for performing corrections in the subsequent cycles.

As explained in the description of this document, the method comprises performing a measurement of several parameters during operations of boring then of riveting, to achieve a statistical control of the boring-riveting process and possibly to modify the position of the tools carrying out the process if the trend ascertained by the set of parameters shows a negative evolution of the performance of one or both operations.

In the context of statistical process control, such a process can be subject to a calculation of the indices of its capability to achieve the desired positioning. These indices of capability in the context of a process are designated by the letters CP and CPK. The CP index takes into account the tolerance interval and the estimated standard deviation. The CPK index additionally takes into account adjustment of the machines. An example of the use of statistical process control is set forth in the international document number WO97/01802, which describes a method for establishing statistical dimensional tolerance limits for the design of detail parts to enable accurate prediction of the degree of economically acceptable nonconformity for a large, flexible final assembly made from detail parts and having a set of predetermined dimensional tolerances. In this method, a preferred assembly sequence for assembling the detail parts in the assembly is selected and validated. The position, the number, and the size of the coordination features that must be manufactured in the aforementioned detail elements are selected, the aforementioned coordination features being those by which the parts are positioned relative to the others and fastened together to form the assembly. The statistical dimensional tolerances of the individual parts are established as criteria of fabrication for the parts in a manner to allow the parts to be economically produced and assembled in the assemblies and to meet the predetermined dimensional tolerance criteria of the final assembly. The statistical dimensional tolerances of the individual parts are broader than the conventional tolerances that are established to assure the acceptable assemblies when the parts are assembled according to their extreme tolerances, stacked according to the method of the worst case. The parts are produced according to the individual statistical dimensional tolerances with the aid of a capable process, having a CPK equal to at least 1 while holding the average values of the statistically determined dimensions for the individual parts within a predetermined percentage of the nominal dimension. The final result is assembled according to the preferred sequence of mounting by positioning the parts with respect to the others and taking into account coordination features.

Reading this document, it appears that, as for the preceding document, the dimensioning tolerances of the individual parts are fixed a posteriori from the tolerances that must be adhered to on the final mounting and that are verified a posteriori. The possibility that these final tolerances on the assembly are not adhered to has, in the context of this method, the consequence of a retightening of the fabrication tolerances of the individual parts, making their fabrication particularly costly or even difficult to implement.

A process is today traditionally considered as capable if the CP index is greater than or equal to 1.33. Nevertheless, the increasingly rigorous tolerances demanded, in the context of positioning of the rivet having a countersunk head within a countersunk orifice, for example, require that the CPK also be greater than or equal to 1.33, signifying not only that the process is capable but also that the machines are well adjusted. As a consequence of the evolution of the aforementioned tolerances, the aforementioned threshold of 1.33 may be reviewed and possibly raised.

These requirements are illustrated by the drawings of FIGS. 1, 2, and 3.

The drawing of FIG. 1 illustrates a normal dimensions distribution curve C of a batch of parts, for example of rivets, with respect to the number of parts. The ends of the curve C are inscribed within the tolerance interval delimited by a lower tolerance Ti and a higher tolerance Ts. Similarly, the interval between the two ends of the curve, equal to six times the estimated standard deviation, is confounded with the interval between the upper and lower tolerances.

The drawing of FIG. 2 illustrates a normal dimensions distribution curve C of a batch of parts on the basis of a process with a CP greater than or equal to 1.33 where the tighter parts tolerance curve, i.e. with a smaller estimated standard deviation, moves within a given tolerance.

The curve drawn on FIG. 3 defines the objective to attain in the context of a process of which the CPK is greater than or equal to 1.33 and in which the tighter parts tolerances curve is positioned at the center of the given tolerance, i.e. centered on an average value.

If in the context of the example of the setting of a rivet having a countersunk head within a countersink, the curve of FIG. 2 is generally achieved, that of FIG. 3 is by far less achieved. In fact, the process of making the rivets is already subject to the calculation of the CP index and it is possible to obtain very homogeneous fabrication batches conforming to the requested tolerances. In the context of an entire process of boring-riveting where the tolerances of the parts to be set are only one of the tolerances to take into account, it is much more difficult to achieve the desired CPK that can require, to achieve tighter tolerances curves, not only for the parts but also for the realization of the countersink, an accurate tracking of variations particularly regarding the wear and tear of the fabrication tools, which presents a prohibitive cost of implementation and operating.

The anticipated augmentation of the CPK leads to such costs or alternatively to the incapacity of the realization of such a process in the desired tolerances.

### BRIEF DESCRIPTION OF THE INVENTION

Noting this, the applicants conducted research studies to facilitate the attainment of a CPK greater than or equal to 1.33 and to enable the realization of future processes attaining higher CPKs.

These research studies have resulted in a manufacturing process of the kind that requires an accurate positioning of the fastening parts relative to a receiving part capable of receiving it, the positioning being carried out by means of equipment provided therefore, characterized in that it comprises measuring the parts subject to be positioned to ascertain the tolerance curve of the aforementioned parts and modifying the adjustment of the positioning equipment such that the tolerance curve for dimensioning the parts is situated in the center of the positioning tolerance zone.

This feature is particularly advantageous as it enables obtaining the CPK higher than 1.33. This feature is particularly innovative in that it combines two methods that have been used only separately so far.

Thus, in the context of positioning the rivets, the calculation of the CP enabled the manufacturer of rivets to attain the demanded dimensioning tolerances for the rivet and to provide the conformance to these tolerances to the user of the rivet. In like manner, the user of the rivet, starting from a purchased batch, provided the adjustment of the equipment, verified the tolerances of positioning, and implemented the operation. When another batch of rivets was used, the adjustment and the verification were carried out anew.

What the applicants propose is different, taking advantage of a datum known but not used up to now by the user of the parts, i.e. the dimensioning tolerances of the batch of parts measured to provide the adjustment of the equipment itself. Thus, the input of this data, resulting from an independent manufacturing process and carried out before assembly, into the software or the operating program of the tool enables taking it into account and providing a positioning of the equipment taking into account the aforementioned tolerances curve. In fact, by knowing the distribution curve for dimensioning the parts as well as its position relative to the positioning interval, the invention offers adjustment of the equipment so that arrangement of the orifice capable of receiving the rivet made by the adjusted tool takes into account the average value of the dimensions of the batch of parts that must be used, so that this average value comes to be situated towards the middle of the positioning tolerance interval. In the prior art, for example in the method described in the international document number WO 97/01802, the knowledge of the distribution curve for dimensioning the parts as well as its positioning within the interval of positioning tolerance had no other purpose than to know if the measured batch of parts was likely to obtain the desired CPK, whereas the method of the present invention offers a real exploitation of this data for the adjustment of the tool and the achievement of an appropriate CPK.

In the context of a manufacturing process using a countersinking tool associated with a riveting tool, the method is characterized in that the positioning and the depth of the countersinking will be performed taking into account the tolerances curve of the batch of rivets, in order to center the latter on the middle of the positioning tolerance zone, and to obtain thus a CPK at least superior or equal to 1.33. Thus, the method of the invention does not have the purpose to use statistical process control on the assembly in order to assess the manufacturing tolerances of the parts or rivets being part of the assembly, but to take into account the results previously known and resulting from statistical process control, applied to the manufacturing of the aforementioned parts, possibly to modify the adjustment of the tool providing the final setting process.

Of course there exists in the prior art machine tools such as piercing/riveting machines taking into account the data tied to the rivets or fastening parts they must handle in order to possibly change the tool or the configuration. Nevertheless, the aforementioned data did not include any further detail than the nominal dimensions or the type of rivets, as the aforementioned rivets are supposed to be manufactured according to an appropriate CP or CPK of rivet manufacturing process. What the invention offers is that the machine tool uses the data constituted by the knowledge of the tolerance curve and the position of the tolerance curve for the manufacturing of the rivets by the tool having to implement the assembly process.

Another object of the invention relates to a software product capable of controlling the method of the invention to the end of commanding the tool using measured parts.

The fundamental concepts having just been described above in their most elementary form, further details and features will reemerge more clearly by reading the following description supported by the annexed drawings, giving as a non limitative example, a mode of implementation of a method and of a software product in accordance with the invention.

### BRIEF DESCRIPTION OF THE DRAWINGS

FIG. 1 is a schematic drawing of a normal distribution curve of dimensions of a batch of parts with respect to the number of parts,

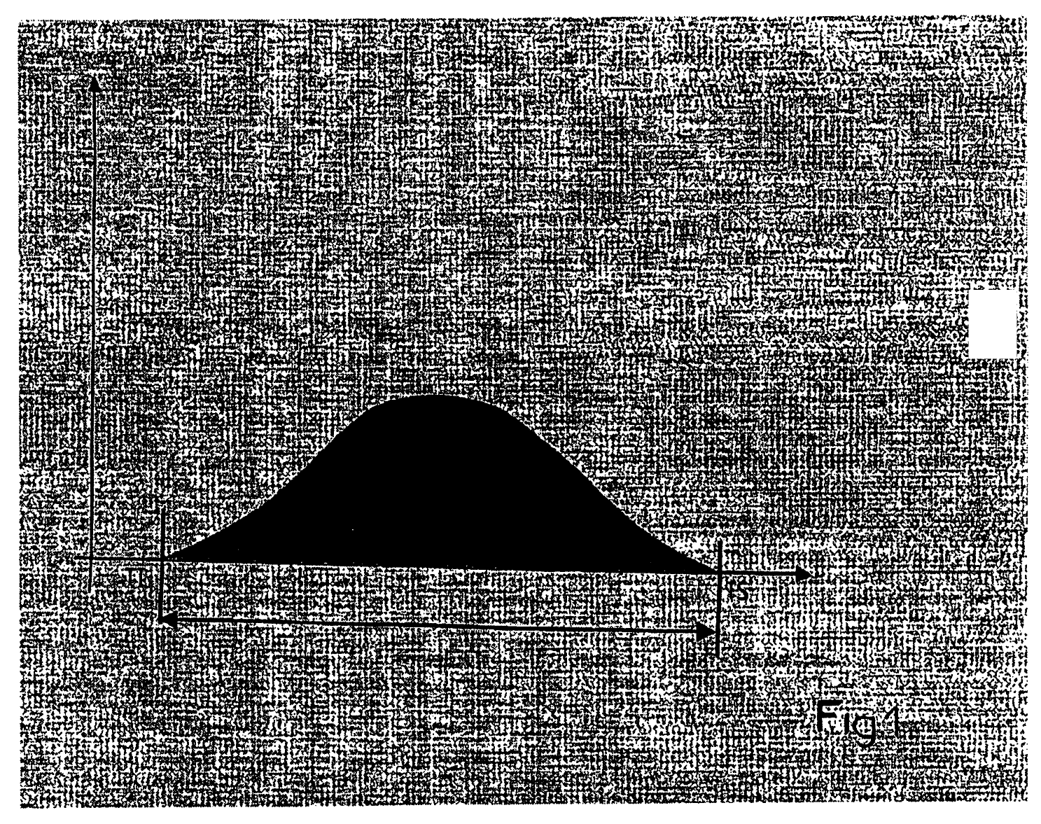

FIG. 2 is a schematic drawing of a normal distribution curve of dimensions of a batch of parts with respect to the number of parts conforming to a CP greater than or equal to 1.33,

FIG. 3 is a schematic drawing of a normal distribution curve of dimensions of a batch of parts with respect to the number of parts conforming to a CPK greater than or equal to 1.33,

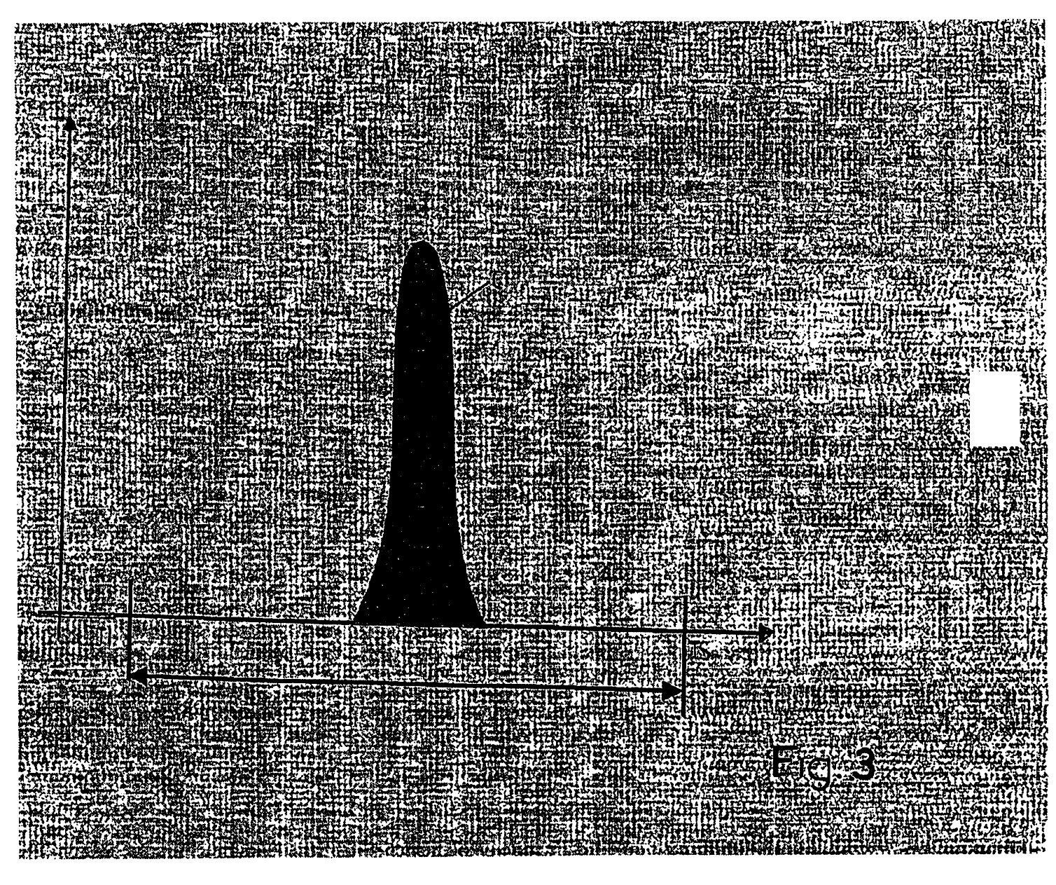

FIG. 4 is a schematic drawing illustrating the effects of a first implementation mode of the method of the invention,

FIG. 5 is a schematic drawing illustrating the effects of a second implementation mode of the method of the invention.

### DESCRIPTION OF THE INVENTION SUPPORTED BY THE DRAWINGS

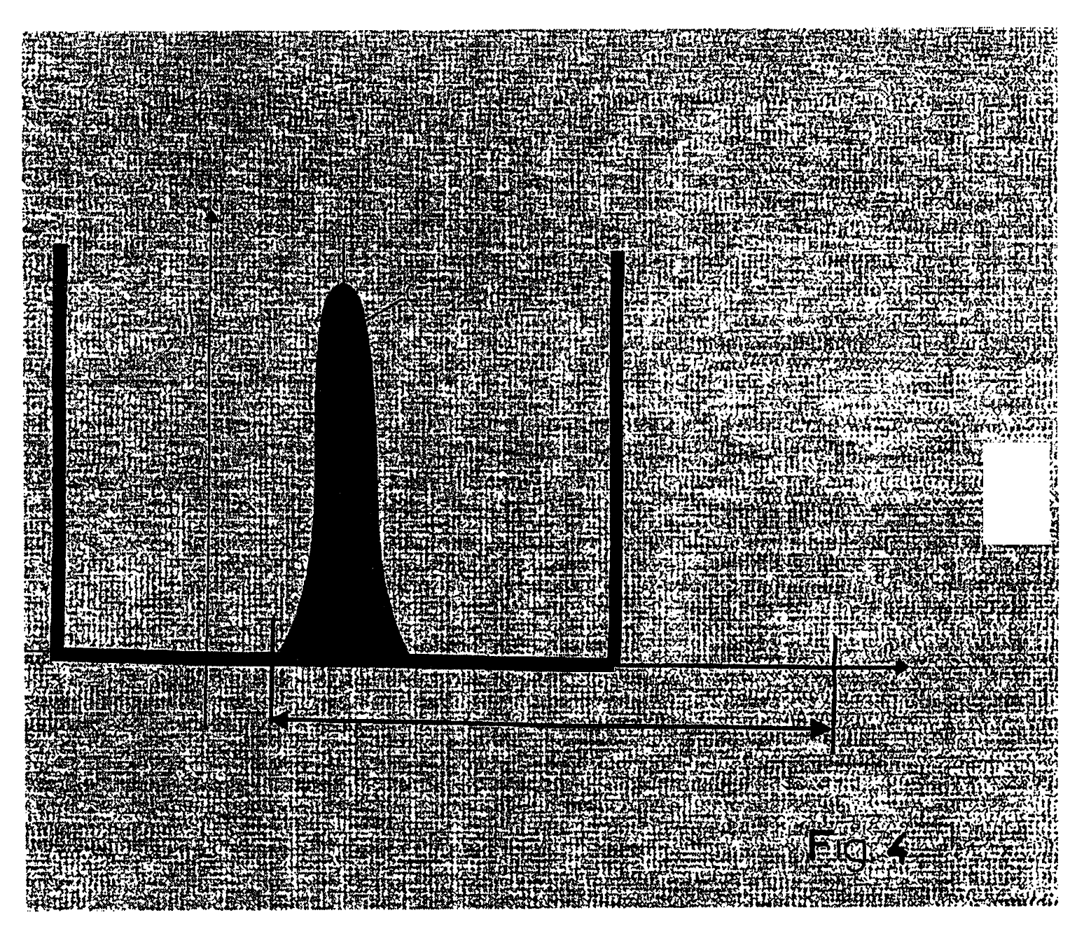

The result of the adjustment offered by the method of the invention is illustrated on the drawing of FIG. 4 where the positioning tolerance interval (in bold) is advantageously modified by tool adjustment in order to enable the centering of the rivet dimensions distribution curve C on the middle of the tolerance interval, which is manifested by a shift of the positioning tolerance interval towards the left.

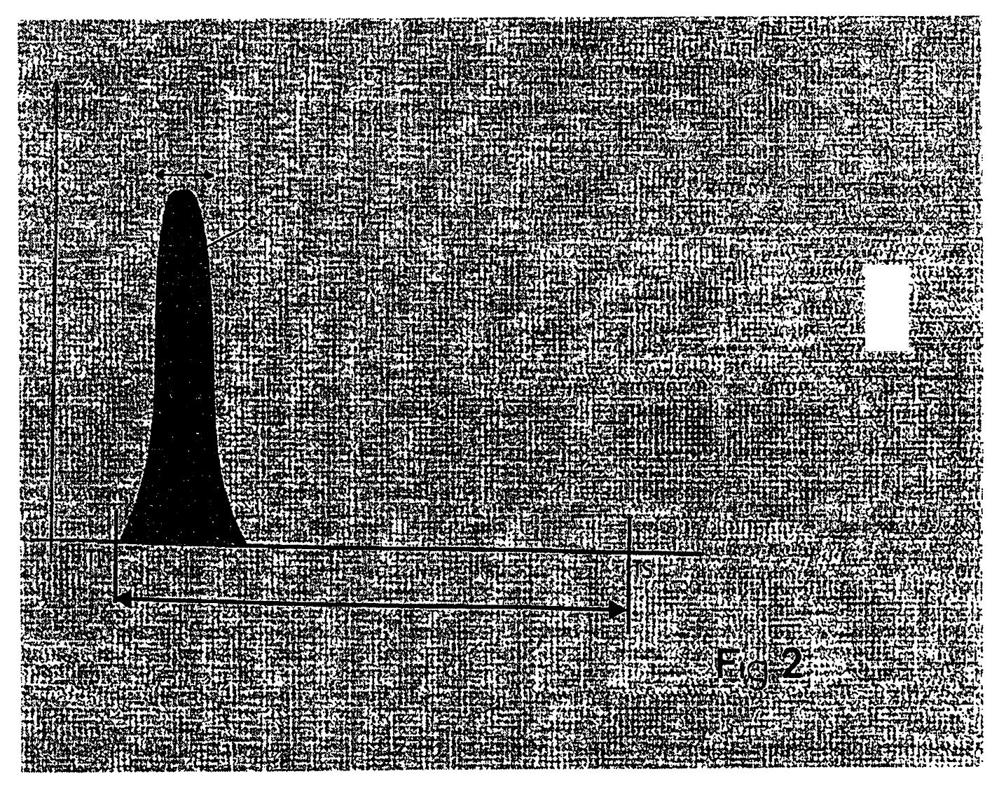

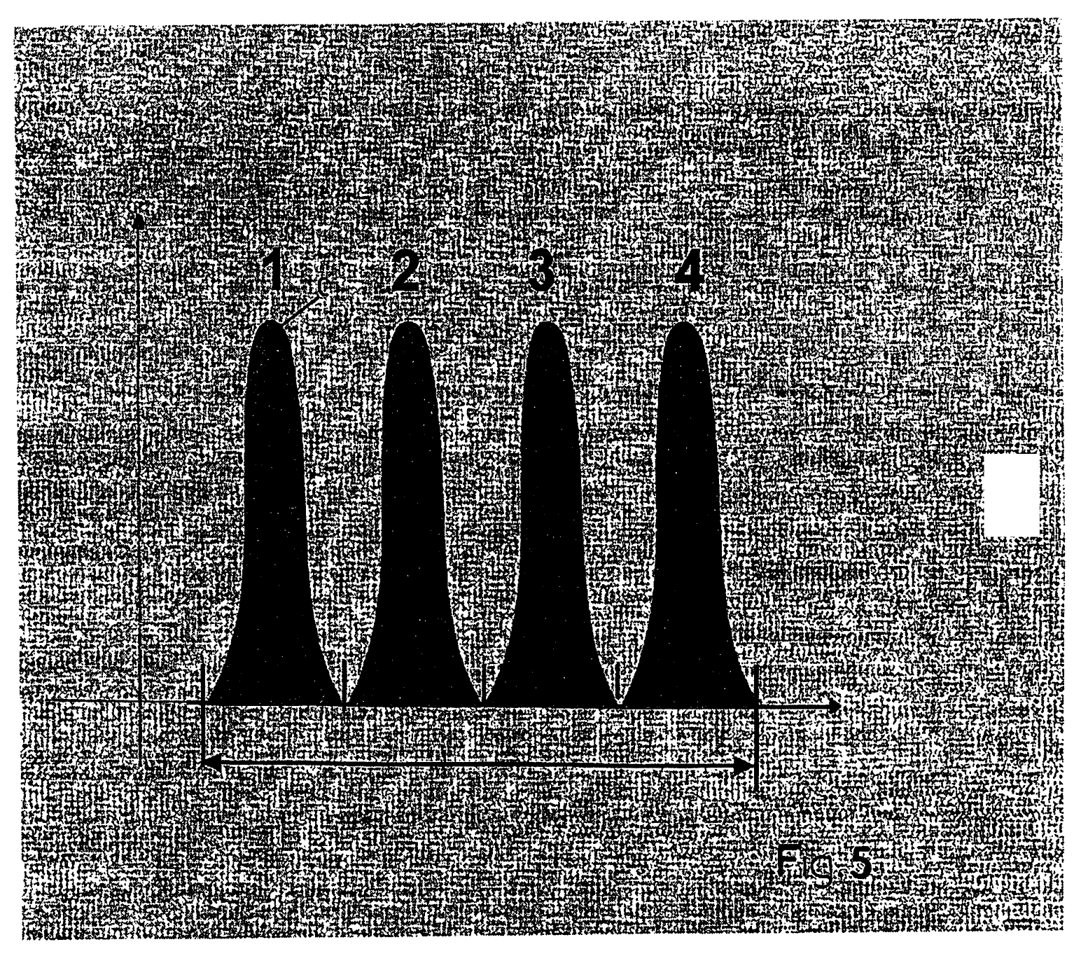

This FIG. 5 illustrates a distribution curve C of dimensions or tolerance curve of a batch of parts with respect to a positioning tolerance interval. This curve C, conforming to the teaching of FIG. 2, represents a CP greater than or equal to 1.33. Nevertheless, from the fact of its excentration with respect to the average value of the positioning tolerance interval, such a batch cannot enable as it is, without adequate tool adjustment, achievement of a CPK greater than or equal to 1.33. The method of the invention offers taking into account this excentration for adjusting, before placing the part into position, the tool providing the countersinking in the case of a boring-riveting tool by means of rivets having countersunk heads or providing the reception hole in the case of a more general method.

As illustrated on the drawing of FIG. 5, in order to simplify the process and to adapt to equipment not capable of fine adjustment, the applicants invented a method characterized in that it comprises measuring the parts dimensioning tolerance curve, in a manner to be able to situate, using theory, its center in one of the four positioning tolerance sub-intervals, result of the arbitrary division in four of the positioning tolerance interval taken as reference, and to offer at least four tool adjustments according to one of the four sub-intervals concerned for centering the middle of the detected tolerance subinterval with the middle of the positioning tolerance interval.

In the context of a riveting process, as the batches of rivets are likely to be very homogeneous, it is possible to determine the position of the dimensioning tolerance curve at the end of rivet manufacturing. This information, capable of having modified the adjustment of the tool using the rivets, must be able to be communicated to the aforementioned tool.

The applicants have advantageously invented, in the context of a process or of a device using containers or cassettes of parts, that the aforementioned containers or cassettes bear, on their surface, information about the shape and the position of the distribution curve (C) of the dimensions of the stored parts belonging to the measured batch. These cassettes or containers adapted to this method have therefore the characteristic that makes readable by any means the information related to the shape and position of the parts dimensions distribution curve of the parts that they contain. The information presented on the containers of the prior art contain data much more basic concerning the nominal dimensions and the type of the stored parts that does not have the aim to modify the positioning of the tools according to the batch of parts but to enable the machine-tool to select these parts, to choose the correct means to distribute them and to possibly modify/change the tools suitable for operating on them.

Thus, by reading the aforementioned information, a reading subpart can transmit the information to the tool on the operating site and obtain the desired CPK. This information can be used in the context of the device described and illustrated in the international application number PCT/FR03/02201, which describes a means of storage and of distribution of parts such as the rivets that is presented in the form of a column of cassettes in front of which a mobile head for reading and multitube distribution comes to position itself. In the context of the invention, the information present on the cassettes permits not only positioning the head before the correct cassette according to the part requested by the plan of fabrication procedure but also to furnish, to the tool having to handle the distributed part, the information on the position of the tolerance curve, to effectuate the adequate adjustment on the tool and to attain the desired CPK.

This feature is particularly advantageous in that the ordering system by cassette or container was developed in the context of a storage and distribution system for rivets, or for parts such as the rivets, that provides a plurality of containers or of cassettes and therefore in general of parts of different dimensions and/or batches, containers or cassettes with which cooperates a reading and distribution module of the aforementioned parts towards one or several tools. Thus, while in the prior art, conformance to the CPK had to require a manual or visual verification for each assembly in order to establish an average equipment adjustment appropriate for all the used batches of fastenings, the method of the invention enables a saving of precious time by providing parts containers receiving on their surface, or on any other place subject to be accessible to a reading means, the information concerning the dimensions distribution curve of the parts that it stores.

The invention also relates to a control software product for at least a tool for making a receiving hole for a part, adapted to the method of the invention and characterized in that, on the basis of the data related to the shape and position of the curve of distribution dimensions corresponding to the part to be positioned, the positioning of the tool is modified so that the aforementioned distribution curve comes to center itself on the tolerance positioning interval defined by the making of the receiving hole.

One understands that the method and the software product, that have just been described and represented above, were with a view to a disclosure rather than a limitation. Of course, various arrangements, modifications and improvements can be applied to the example above without departing from the context of the invention as defined in the claims.

1. A method of fabrication of the type that requires precise positioning of fastening parts with respect to a reception part suitable to receive it, the positioning being realized by means of equipment provided to this effect, characterized in that it comprises measuring the parts subject to being positioned for knowing the tolerance curve of the aforementioned parts and modifying the adjustments of the positioning tool so that the tolerance curve of parts dimensioning is situated at the middle of the positioning tolerance zone.

2. The fabrication method according to claim 1, characterized in that it comprises measuring the tolerance curve of dimensioning of the parts in a manner to be able to situate, using theory, its center and one of the four sub-intervals of tolerance of positioning resulting from the arbitrary division in four of the positioning tolerance interval taken as reference and to propose four adjustments of the tool according to one of the four sub-intervals concerned for centering the middle of the found sub-interval of tolerance with the middle of the interval of positioning tolerance.

3. The fabrication method according to claim 1, using containers or cassettes of parts, characterized by the fact that the aforementioned containers or cassettes bearing on their surface information about the shape and the position of the distribution curve of dimensions of stored parts belonging to the measured batch.

4. The fabrication method according to claim 3, using a storage module of parts composed of a plurality of containers with which cooperate a module for reading and distribution of the aforementioned parts towards one or several tools, characterized by the fact that the information present on the cassettes enables not only to position the head before the correct cassette according to the part requested by the plan of fabrication procedure but also to furnish to the tool having to use the distributed part, the information about the position of its tolerance curve, for effectuating the adequate adjustment on the tool and attaining the desired CPK.

5. The fabrication method according to claim 1 of the type of that exploiting a countersinking tool associated with a riveting tool, characterized in that the positioning of the depth of the countersink will be realized taken into account the tolerances curve of the batch of rivets in order to center the latter on the middle of the zone of positioning tolerance and to obtain in this manner a CPK greater than or equal to 1.33.

6. A control software product for a tool for making a receiving hole for a part, adapted to the method according to claim 1, characterized by the fact that on the basis of the data relating to the shape and the position of the dimensions distribution curve to which correspond the part to be positioned, the positioning of the tool is modified so that the aforementioned distribution curve comes to be centered on the tolerances interval of positioning defined by the making of the receiving hole.

7. A method for fastening parts with respect to reception parts, the method comprising:
measuring the parts subject to being positioned, to determine the tolerance curve of the parts; and
modifying an adjustment of a positioning tool so that the tolerance curve is situated at the middle of the positioning tolerance zone.

8. The fabrication method according to claim 7 wherein measuring includes measuring to situate the center of the curve and one of the four sub-intervals of tolerance of positioning resulting from a division in four of the positioning tolerance interval taken as reference and to propose four adjustments of the tool according to one of the four sub-intervals to center the middle of the found sub-interval of tolerance with the middle of the interval of positioning tolerance.

9. The fabrication method according to claim 7 further including using containers or cassettes of parts, wherein the containers or cassettes include information about the shape and the position of the distribution curve of dimensions of parts stored therein.

10. The fabrication method according to claim 7 wherein a positioning of a depth of a countersink is realized taken into account the tolerances curve of a batch of rivets in order to center the curve on the middle of a zone of positioning tolerance and to obtain in this manner a CPK greater than or equal to 1.33.

11. A control software product for a tool for making a receiving hole for a part, adapted to the method according to claim 7, wherein, on the basis of the data relating to the shape and the position of the dimensions distribution curve corresponding to the part to be positioned, the positioning of a tool is modified so that the distribution curve comes is centered on the tolerances interval of positioning defined by the making of the receiving hole.
